(19) United States
(12) Patent Application Publication
(10) Pub. No.: US 2002/0017324 A1
(43) Pub. Date: Feb. 14, 2002

(54) Magnet valve

(76) Inventors: Tetsuya Hisamura, Ishikawa-Ken (JP); Katsuji Tsuruyama, Ishikawa-Ken (JP)

Correspondence Address: FLYNN, THIEL, BOUTELL & TANIS, P.C., 2026 Rambling Road, Kalamazoo, MI, 49008-1699, US

(21) Appl. No.: 09/858,031

(22) Filed: May 15, 2001

(30) Foreign Application Priority Data
Aug. 11, 2000 (JP) 244771/2000

(51) Int. Cl. F16K 37/00

(52) U.S. Cl. 137/554; 251/65

(57) ABSTRACT

A magnet 18 is embedded within a lower portion of a valve element 13, and a magnet 21 is provided on a drive member 15 to achieve a magnetic coupling between the driver member 15 and the valve element 13. When the drive member 15 is driven upward to its uppermost end position shown in FIG. 2, the valve element 13 is also driven upward to its open position, whereby a valve section 13a is spaced from a valve seat 17 to open a channel 11, allowing a vessel 4 to be filled with a liquid. A detected portion in the form of a magnet 34 is embedded in the upper portion of the valve element 13, while a magnetic force detector 35 for detecting a magnetic force from the magnet 34 is provided. The arrangement allows the opening and closing operation of the valve element 13 to be detected accurately by means of the magnetic force detector 35.

### FIELD OF THE INVENTION

The invention relates to a magnet valve which utilizes a magnetic force to operate a valve element for opening and closing, and more particularly, to a magnet valve for use in a filler.

### DESCRIPTION OF THE PRIOR ART

For use in a filler which is used in filling a vessel with a liquid, a magnet valve is known in the art comprising a channel formed in a housing, a valve seat formed intermediate the length of the channel, a valve element movably disposed within the channel to close it when the valve element is seated on the valve seat, a drive member disposed to be movable outside the channel and magnetically coupled to the valve element, and a drive unit for moving the drive member so that the valve element is movable between a closed position in which it is seated on the valve seat and an open position in which it is spaced from the valve seat (see Japanese Laid-Open Patent Application No. 325, 302/99, for example).

Because the magnet valve is constructed so that the valve element which opens and closes the channel is separate from the drive unit which is used to move it as will be noted in the prior art, the channel structure is simple enough to be cleanable and thus is suitable for use with a filling operation which requires a high level of sterility. For this reason, it finds application in a filler which is used to fill an ampoule with a liquid medicine.

When filling an ampoule with a liquid medicine, if a failure to open the valve occurs during the operation of the filler, an empty ampoule results, and the small size of the vessel (ampoule) and the extremely small quantity of the filled content may lead to a difficulty of an inspecting personnel to find such ample, resulting in the likelihood that rejects may be produced in large quantities. Accordingly, there is a need for a continued detection of an open valve condition in an ampoule filler. As regards the magnet valve, the operation of the drive unit which moves the valve element must be monitored, and in the event of a failure to operate as commanded, an alarm must be issued to interrupt the operation of the filler.

However, because the valve element is a separate member in the magnet valve as mentioned above, a technique of monitoring the operation of the drive unit is only capable of providing an indirect indication of the open valve condition, and there remains a concern that the valve element may fail to move for some reason even though the drive unit operates normally.

### SUMMARY OF THE INVENTION

In view of the foregoing, in the magnet valve including a channel formed in a housing, a valve seat formed intermediate the length of the channel, a valve element movably disposed within the channel to close it when the valve element is seated on the valve seat, a drive member disposed to be movable outside the channel and magnetically coupled to the valve element, and a drive unit for moving the drive member so that the valve element is movable between a closed position in which it is seated on the valve seat and an open position in which it is spaced from the valve seat, in accordance with the present invention, there are provided a detected portion which is integral with the valve element, and detecting means for detecting the position of the detected portion.

With the described construction, an opening and closing operation of the valve element can be detected accurately by detecting the position of the detected portion which is integral with the valve element by using the detecting means.

Above and other features, objects and effects of the present invention will become apparent from the following description with reference to the attached drawings.

### BRIEF DESCRIPTION OF THE DRAWINGS

FIG. 1 is a schematic plan view of a rotary filler illustrating one embodiment of the present invention; and

FIG. 2 is a cross section of a magnet valve 3 according to the present invention.

### DETAILED DESCRIPTION OF THE EMBODIMENTS

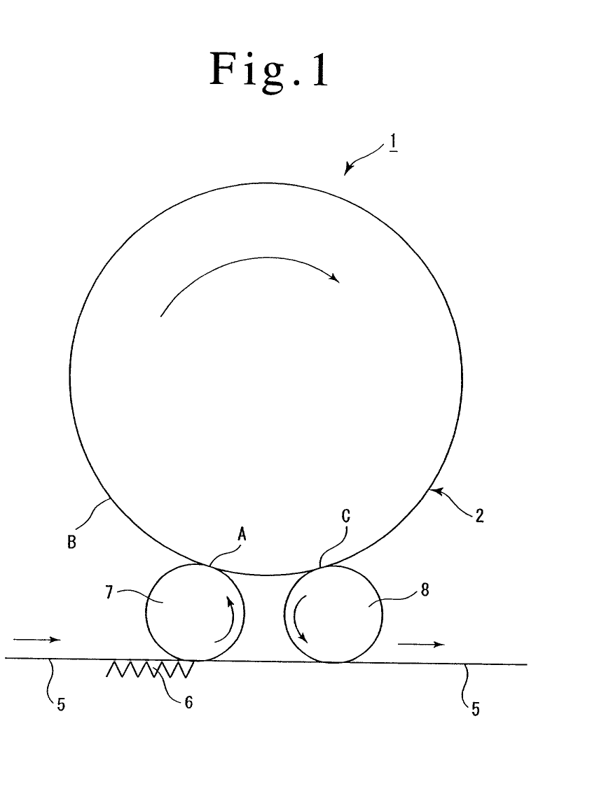

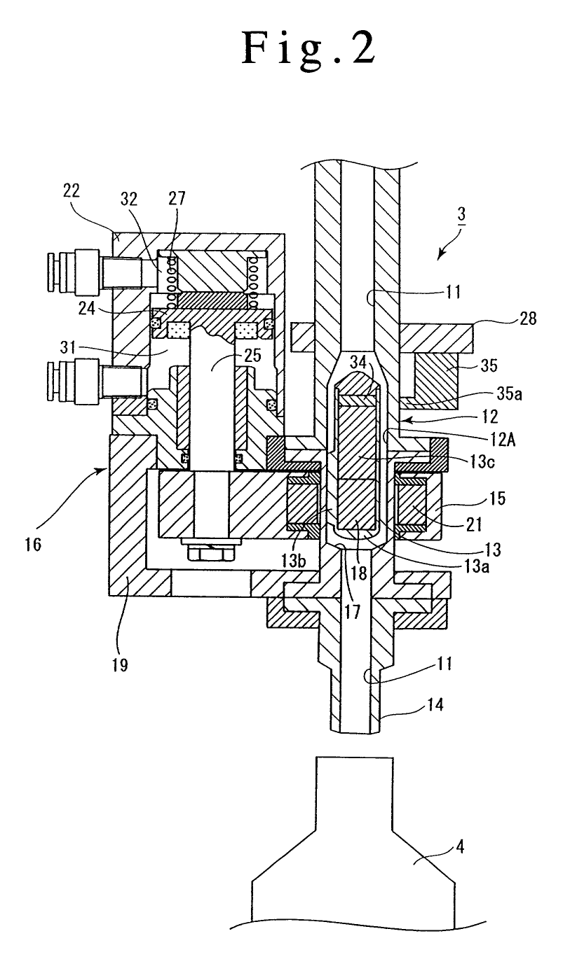

Referring to the drawings, an embodiment of the present invention will now be described. In FIG. 1, a rotary filler 1 includes a revolving body 2 which rotates clockwise continuously. Magnet valves 3 (see FIG. 2) are disposed around the outer periphery of the revolving body 2 at an equal interval circumferentially, and holder means for holding a vessel such as ampoule is provided in correspondence to each magnet valve 3.

A vessel 4 which is conveyed on a conveyor 5 is handed by a timing screw 6 onto a supply star wheel 7 which rotates in synchronism with the revolving body 2 and is supplied to the revolving body 2 at a supply location A. When the vessel 4 is conveyed to a filling location B by the rotation of the revolving body 2, a magnet valve 3 is opened to initiate a filling operation in response to a valve open command from a controller, not shown.

Subsequently, as the filling operation proceeds, a timer within the controller recognizes that a given length of time has passed since initiating the filling operation, and the controller delivers a valve close command, which is effective to close the magnet valve 3. In this manner, a given quantity of a liquid to be filled is filled into the vessel 4, which is then discharged by a discharge star wheel 8 from the revolving body 2 onto the conveyor 5 at a discharge location C.

The construction of the magnet valve 3 which forms the heart of the present invention will now be described. Referring to FIG. 2, the magnet valve 3 comprises a tubular housing 12, the internal space of which defines a channel 11 through which the liquid to be filled passes, a solid cylindrical valve element 13 which is received within the housing 12 and is vertically movable, and a drive unit 16 which moves the valve element 13 through a drive member 15 which is magnetically coupled thereto.

The housing 12, which is formed by a cylindrical member, is disposed in a vertical position, and has an upper end connected to a pipe, not shown, which serves introducing the liquid to be filled into the channel 11 from a liquid tank. The housing 12 has a lower end which is connected to a nozzle 14, the internal space of which also defines part of the channel 11.

In a given region, the channel 11 in the housing 12 has a greater diameter as shown at 12A than the remainder, and the lower end of the increased diameter portion 12A forms a valve seat 17 which surrounds the channel 11. The valve element 13 is received in the increased diameter portion 12A, and is vertically movable within the portion 12A, it being understood that the liquid to be filled can pass through a space between the inner peripheral surface of the increased diameter portion 12A and the outer peripheral surface of the valve element 13.

The valve element 13 is in the form of a solid cylinder, and has radially projecting vane-shaped guides 13b around the outer periphery thereof at three circumferential locations. The valve element 13 is disposed so that a body in the form of a solid cylinder is aligned with the center of the internal diameter of the channel 11. The valve element 13 has a lower spherical end face which serves as a valve section, and the channel 11 is closed when the valve section 13a is seated on the valve seat 17. A magnet 18 is embedded within the valve element 13 toward its lower end.

A drive member 15 is disposed in surrounding relationship with the outer periphery of the housing 12 at a location outside the channel 11, and is slidable along the outer peripheral surface of the housing 12 so that it is movable lengthwise of the hosing 12 in a manner corresponding to an extent over which the magnet 18 embedded in the valve element 13 moves within the increased diameter portion 12A of the channel 11. A ring-shaped magnet 21 is embedded in a portion of the drive member 15 which surrounds the housing 12, and a magnetic coupling is achieved between the magnet 21 and the magnet 18 which is embedded in the valve element 13.

The drive member 15 is connected to a drive unit 16 such that when the drive member 15 is moved to its lowermost position by the drive unit 16, the valve element 13 moves in following relationship therewith to cause the valve section 13a to be seated on the valve seat 17 at a closed position, thus closing the channel 11. When the drive member 15 is moved to its uppermost position shown in FIG. 2 by the drive unit 16, the valve element 13 again moves in following relationship therewith, whereby the valve section 13a is positioned at its open position which is spaced from the valve seat 17, thus opening the channel 11.

The drive unit 16 which is used to move the drive member 15 is mounted integrally on the housing 12 through a bracket 19 and comprises an air cylinder 22 including a piston 24, from which a piston rod 25 depends downwardly, the drive member 15 being secured at its one end to the free end of the piston rod 25.

A first pressure chamber 31 which is disposed below the piston 24 is connected to a source of compressed air through a flow path switching valve, not shown, which is provided in the drive unit 16 while a second pressure chamber 32 which is located above the piston is open to the atmosphere. When the compressed air is introduced into the first pressure chamber 31 in response to a valve open command from the controller, not shown, the piston 24 is driven upward, causing the drive member 15 to move to its uppermost position shown in FIG. 2, whereby the valve element 13 is positioned at its open position to open the channel 11. When the compressed air is displaced from the first pressure chamber 31 in response to a valve close command from the controller, the piston 24 is driven downward by the resilience of a spring 27 disposed within the second pressure chamber 32, thus moving the drive member 15 to its lowermost position, whereby the valve element 13 is positioned at its closed position to close the channel 11.

In this manner, in the present embodiment, by moving the drive member 15 which is coupled to the piston 24 so as to move the valve section 13a of the valve element 13 which is magnetically coupled to the drive member 15 into engagement with or disengagement from the valve seat 17, the channel 11 can be closed and opened.

The magnet valve constructed in the manner as mentioned above has an arrangement which permits the opening and closing operation of the valve element 13 to be detected when the valve element 13 is driven by the drive unit 16.

Specifically, a magnet 34 which is used for detecting purpose is embedded in an upper portion of the valve element 13 with an intermediate member 13c interposed between the top end of the valve element 13 and the magnet 18, thus providing a detected portion in an integral manner with the valve element 13. In addition, a magnetic force detector 35, which is mounted on the outer periphery of the housing 12 by means of a bracket 28, serves as detecting means which detects the position of the detected portion comprising the magnet 34. The magnetic force detector 35 includes a detecting portion 35a which is located so that its position corresponds to the position of the detected magnet 34 when the valve element 13 assumes the open position, thus allowing the magnetic force obtained at this position to be detected.

As a result of the described arrangement, the magnetic force detector 35 is capable of detecting an increase in the magnetic force from the magnet 34 when the valve element 13 has reached its uppermost end or open position, and a decrease in the magnetic force from the magnet 34 when the valve element 13 reaches its lowermost or closed position, thus feeding a detection signal to the controller, not shown. The controller then compares the detection signal which is input against a preset threshold valve, thus affording a recognition that the valve element 13 is at its open position and the valve is opened if the magnetic force exceeds the threshold value. In the event the input detection signal from the magnetic force detector 35 does not exceed the threshold value after the controller has delivered the valve open command to the drive unit 16, a decision is rendered that the valve element 13 is not positioned at its open position and the valve is not normally opened, thus issuing an alarm and interrupting the operation of the filler. Also, in the event the detection signal which is input from the magnetic source detector 35 fails to undershoot the threshold value after the valve close command is delivered to the drive unit 16 even though the detection signal has once exceeded the threshold value, a decision is rendered that the valve element 13 has not reached the closed position where it is seated upon the valve seat 17 and thus the valve is not normally closed, again issuing an alarm and interrupting the operation of the filler.

The detected magnet 34 is chosen to be of a lesser magnetic magnitude than the magnet 18 which is embedded within the valve element 13 and which is magnetically coupled to the magnet 21 on the drive member 15 to transmit a drive in order to prevent that the magnetic force from the detected magnet 34 interferes with the magnetic coupling of the magnet 18 to thereby influence upon a normal movement of the valve 13 in following relationship with the movement of the drive member 15.

As discussed above, with the present embodiment, by detecting the magnetic force from the magnet 34 which is integrally mounted on the valve element 13 by means of the magnetic force detector 35, it is possible to detect accurately whether or not the valve element 13 is positioned at its open position. As a consequence, if a failure occurs that the valve element 13 is positioned at its closed position and the channel 11 can not be opened for some reason when the drive unit 16 is operated to position the drive member 15 at its uppermost end, as shown in FIG. 2, this can be immediately detected.

While the invention has been described above in connection with the rotary filler 11, it is also applicable to an on-line filler. It should be understood that the disposition of the magnet valve 3 (or the housing 12) is not limited to a vertical position, but can be modified as required.

While the invention has been described above in connection with an embodiment thereof, it should be understood that a number of changes, modifications and substitutions therein are possible from the above disclosure without departing from the spirit and the scope of the present invention.

What is claimed is:

1. A magnet valve including a channel formed in a housing, a valve seat formed intermediate the length of the channel, a valve element movably disposed within the channel to close it when the valve element is seated on the valve seat, a drive member disposed to be movable outside the channel and magnetically coupled to the valve element, and a drive unit for moving the drive member so that the valve element is movable between a closed position in which it is seated on the valve seat and an open position in which it is spaced from the valve seat;
characterized by a detected portion which is integrally provided on the valve element, and detecting means for detecting the position of the detected portion.

2. A magnet valve according to Clam 1 in which the valve element contains a magnet which is magnetically coupled to the drive member, the detected portion comprising a magnet of a lesser magnetic magnitude than the magnet in the valve element, and the detecting means comprising a magnetic force detector which detects a magnetic force.
